(19) United States
(12) Patent Application Publication
(10) Pub. No.: US 2008/0182982 A1
(43) Pub. Date: Jul. 31, 2008

(54) METHYL ESTERS OF HYALURONIC ACID

(75) Inventors: Vineer Kumar, East Brunswick, NJ (US); Fanny Longin, Frederiksberg (DK); Khadija Schwach-Abdellaoui, Frederiksberg (DK); Richard A. Gross, Plainview, NY (US)

Correspondence Address: NOVOZYMES NORTH AMERICA, INC., 500 FIFTH AVENUE, SUITE 1600, NEW YORK, NY, 10110, US

(73) Assignee: Novozymes Biolpolymer A/S, Bagsvaerd (DK)

(21) Appl. No.: 12/018,238

(22) Filed: Jan. 23, 2008

Related U.S. Application Data
(60) Provisional application No. 60/886,549, filed on Jan. 25, 2007.

(51) Int. Cl. C08B 37/00

(52) U.S. Cl. 536/55.3

(57) ABSTRACT

The present invention relates to a method of producing methyl esters of a hyaluronic acid, said method comprising the steps of:
(a) providing a suspension comprising the acid form of the hyaluronic acid in methanol;
(b) adding an organic solution of trimethylsilyldiazomethane to the suspension and mixing, whereby methyl esters of hyaluronic acid are produced; and
(c) recovering the hyaluronic acid methyl esters.

### CROSS-REFERENCE TO RELATED APPLICATIONS

This application claims priority or the benefit under 35 U.S.C. 119 of U.S. provisional application no. 60/886,549 filed Jan. 25, 2007, the contents of which are fully incorporated herein by reference.

### FIELD OF THE INVENTION

The present invention relates to a process for producing methyl esters of hyaluronic acid (HA).

### BACKGROUND OF THE INVENTION

Hyaluronic acid (HA) is a natural and linear carbohydrate polymer belonging to the class of non-sulfated glycosaminoglycans. It is composed of beta-1,3-N-acetyl glucosamine and beta-1,4-glucuronic acid repeating disaccharide units with a molecular weight (MW) up to 6 MDa. HA is present in hyaline cartilage, synovial joint fluid, and skin tissue, both dermis and epidermis. HA may be extracted from natural tissues including the connective tissue of vertebrates, from the human umbilical cord and from cocks' combs. However, it is preferred today to prepare it by microbiological methods to minimize the potential risk of transferring infectious agents, and to increase product uniformity, quality and availability (U.S. Pat. No. 6,951,743; WO 03/0175902).

Numerous roles of HA in the body have been identified. It plays an important role in biological organisms, as a mechanical support for cells of many tissues, such as skin, tendons, muscles and cartilage. HA is involved in key biological processes, such as the moistening of tissues, and lubrication. It is also suspected of having a role in numerous physiological functions, such as adhesion, development, cell motility, cancer, angiogenesis, and wound healing. Due to the unique physical and biological properties of HA (including viscoelasticity, biocompatibility, and biodegradability), HA is employed in a wide range of current and developing applications within cosmetics, opthalmology, rheumatology, drug and gene delivery, wound healing and tissue engineering. The use of HA in some of these applications is limited by the fact that HA is soluble in water even at room temperature, i.e., about 20° C., it is rapidly degraded by hyaluronidase in the body, and it is difficult to process into biomaterials. Chemical modification of HA has therefore been introduced in order to improve the physical and mechanical properties of HA and its in vivo residence time.

There is a description in the literature of the methyl ester of a hyaluronic acid with a high molecular weight obtained by extraction from human umbilical cords (Jeanloz and Forcheilli 1950, J. Biol. Chem., 186: 495-511; and Jager and Winkler, 1979, J. Bacteriology 1065-1067). This ester was obtained by treatment of free hyaluronic acid with diazomethane in ether solution and substantially all the carboxylic groups proved to be esterified. Methyl esters of oligomers of HA with about between 5 and 15 disaccharide units have also been described (Christener, Brown, and Dziewiatkowski, 1977, Biochem. J. 167: 711-716). Also described is a methyl ester of hyaluronic acid etherified with methyl alcohol in a part of the hydroxyl alcohol groups (Jeanloz, 1952, J. Biol. Chem. 194: 141-150; and Jeanloz, 1952, Helvetica Chimica Acta 35: 262271).

Based on skin hydration studies, it has been observed that the skin hydration ability of the methyl esters of hyaluronic acid is enhanced compared to that of native hyaluronic acid (U.S. Pat. No. 4,851,521).

In order to establish a comparison between hyaluronic acid and its derivatives, some experiments have been carried out by della Valle and Romeo (U.S. Pat. No. 4,851,521). Based on these, it was confirmed that the hydration abilities of the methyl esters of hyaluronic acid are better than the native compound.

A process for the preparation of esters of hyaluronic acid is described by della Valle and Romeo (EP Patent No. 216 453 81), where HA is first converted into a quaternary ammonium salt in two steps to render it soluble in an organic solvent and then reacted with an alcohol derivative of the aliphatic, araliphatic, aromatic, cyclic and heterocyclic series. This leads to a compound that is totally or partially esterified at the HA carboxylic group.

In EP Patent No. 1 401 876 B1. Mariotti and co-workers describe new HA derivatives in which the hydroxyl groups are partially or totally esterified and the carboxyl groups are either totally or partially esterified with alcohols or are in the form of salts.

Ferlini, in patent application WO 2005/092929 A1, discloses the preparation and use of butyric esters of hyaluronic acid with a low degree of substitution. A quarternary ammonium salt of HA is reacted with an acylating reagent leading to partial esterification of the hydroxyl groups.

Toida describes a method for producing alkyl-esterified glycosaminoglycans (U.S. Patent Application No. 2006/0172967 A1). The method comprises the step of reacting a trialkylsilyldiazoalkane with hyaluronic acid in dimethylsulfoxide and methanol. Alkyl-esterification takes place at the carboxyl groups and can be either partial or total.

The hydration of the skin and its nourishment seem closely related to the hyaluronic acid content of the cutaneous tissue. It has in fact been demonstrated that the exogeneous application of HA contributes noticeably to the state of hydration of the cutaneous tissue. These particular characteristics of hyaluronic acid are also found, and to an even greater degree, in the esterified derivatives of HA according to the present invention, and for this reason they may be used to a great extent in the field of cosmetics.

Esters of hyaluronic acid may be prepared by methods known per se for the esterification of carboxylic acids, for example by treatment of free hyaluronic acid with the desired alcohols in the presence of catalyzing substances, such as strong inorganic acids or ionic exchangers of the acid type, or with an etherifying agent capable of introducing the desired alcoholic residue in the presence of inorganic or organic bases. As etherifying agents it is possible to use those known in literature, including the esters of various inorganic acids or of organic sulphonic acids, hydracids, that is hydrocarbyl halogenides, methyl or ethyl iodide, or neutral sulphates or hydrocarbyl acids, alfites, carbonates, silicates, phosphites or hydrocarbyl sulfonates, methyl benzene or p-toluenesulfonate or methyl or ethyl chlorosulfonate. The reaction may take place in a suitable solvent, for example an alcohol, preferably that corresponding to the alkyd group to be introduced in the carboxyl group. But the reaction may also take place in non-polar solvents, such as ketones, ethers such as dioxane or aprotic solvents such as dimethylsulphoxide. As a base it is possible to use for example a hydrate of an alkaline or alkaline earth metal or magnesium or silver oxide or a basic salt or one of these metals, such as a carbonate, and, of the organic bases, a tertiary azotized base, such as pyridine or collidine. In the place of the base it is also possible to use an ionic exchanger of the basic type.

Methyl esters of hyaluronic acid may also be prepared to advantage according to another method, which is generally applied to the preparation of carboxylic esters of acidic polysaccharides with carboxyl groups. This method is based on treating a quaternary ammonium salt of an acidic polysaccharide containing carboxyl groups with an etherifying agent, preferably in an aprotic organic solvent. As starting acidic polysaccharides it is possible to use, for example, apart from hyaluronic acid, other acidic polysaccharides of animal or vegetable origin and synthetically modified derivatives of the same, such as acid hemicellulose, obtainable from the alkaline extracts of certain plants and after precipitation of xylans, whose disaccharide components are made up of D-glucuronic acid and D-xylopyranose, (see “The Carbohydrates” by W. Pigman, pages 668-669-R. L. Whistler, W. M. Corbett), the pectins and acidic polysaccharides obtainable from the same, that is, galacturonan, acidic polysaccharides obtainable from plant gum (exudates), such as arabic gum, tragacanth, and finally acidic polysaccharides derived from seaweed, such as agar and carrageenans. As starting material it is of course possible to use also the molecular fractions obtained by degradation of all of the above-mentioned polysaccharides.

The esterification methods known are often carried out by adding by degrees the esterifying agent to the above mentioned ammonium salt to one of the above mentioned solvents, for example to dimethylsulphoxide. As an alkylating agent it is possible to use those mentioned above, especially the hydrocarbyl halogens, for example alkyd halogens. As starting quaternary ammonium salts it is preferable to use the lower ammonium tetraalkylates, with alkyl groups preferably between 1 and 6 carbon atoms. Mostly, hyaluronate of tetrabutylammonium is used. It is possible to prepare these quaternary ammonium salts by reacting a metallic salt of acidic polysaccharide, preferably one of those mentioned above, especially sodium or potassium salt, in aqueous solution with a salified sulphonic resin with a quaternary ammonium base.

In a recent report methyl ester of low molecular weight hyaluronan in which the carboxyl groups were fully esterified was prepared using trimethylsilyl diazomethane (TMSD, Hirano, Sakai, Ishikawa, Avci, Linhardt and Toshihiko Toida, 2005, Carbohydrate Research 340: 2297). Methyl ester was prepared first by conversion of sodium salt of hyaluronan into its acid form. In the process hyaluronan was dissolved in water and applied to a Dowex 50X8 cation exchange column and the acidic fraction was collected and then freeze dried. The prepared hyaluronan (H⁺) was dissolved in a DMSO-methanol (20:1) mixture. The hyaluronan used was of low molecular weight (average mol. weight 20,000 Da) to allow dissolution in DMSO at the concentration used. Trimethylsilyl diazomethane was added to the reaction mixture. The reaction was done for 60 minutes at room temperature. To the resulting reaction mixture acetic acid was added to remove TMSD. It was further treated with ethanol saturated with anhydrous sodium acetate at 0° C. for 1 hr. The reaction mixture was centrifuged and the precipitate was dissolved in water and then acetic acid was added, mixed vigorously and centrifuged at 1000 g. The water layer obtained after centrifugation was dialyzed against water and lyophilized. The resulting product was characterized as methyl ester of hyaluronan. However the method developed by Hirano and co-workers has been applied to low molecular weight HA only to allow their dissolution into DMSO at the concentration used. Furthermore, it requires a number of cumbersome steps to achieve methyl esters as well as use of toxic solvents such as DMSO.

Methyl esters of hyaluronic acid are more stable to enzymes like hyaluronidase and methyl esterase. In addition to this the hydration properties of the new compounds are comparatively better than the native hyaluronic acid (Hirano, Sakai, Ishikawa, Avci, Linhardt and Toshihiko Toida, 2005, Carbohydrate Research 340: 2297).

Therefore there is a need in the art to prepare methyl esters of hyaluronic acid using a simple and facile process. Also the methods should be applicable to both low molecular weight and high molecular weight HA. However the methods known in literature are too complicated and/or involve a series of steps to obtain the final compound.

Diazomethane (CH₂N₂), as previously discussed, is a well-known reagent for methylation reactions (Black, 1983, Aldrichimica Acta 16: 3), but it is highly toxic, thermally labile, and explosive. The use of diazomethane has major drawbacks including (a) the preparation of diazomethane is rather time-consuming and cumbersome; (b) the precursors used for the preparation of diazomethane are potent mutagens and have been classified as carcinogenic substances in the EU; (c) diazomethane itself is also carcinogenic as well as explosive, which complicates its handling. When using diazomethane, it is not possible to control the degree of esterification as practically it is difficult to measure the moles of diazomethane reacted due to very high volatility of the reagent, thereby leading to low reproducibility. Due to the practical difficulties, partial esters have not been prepared using diazomethane so far. The method employing tetrabutyl ammonium salts and further treatment with halo compounds leads to involve many complex processes and use of toxic chemicals.

The disadvantages of diazomethane can be overcome by replacement of one hydrogen of CH₂N₂ by a trimethylsilyl group. The resulting safe and stable trimethylsilyldiazomethane (TMSD) was initially employed mainly for analytical purposes (Hashimoto, Aoyama and Shioiri, 1981, Chem. Pharm. Bull. 29: 1475). In the course of the development of methods for the large-scale preparation of TMSD, this substitute was increasingly used in synthetic applications (Shioiri and Aoyama, 1993, Adv. Use Synthons Org. Chem. 1: 51). TMSD is a thermally stable compound due to the C—Si pπ-dπ resonance. It is a convenient alternative to diazomethane and exhibits many of the reactions of diazomethane including the reaction with carboxylic acids to yield methyl esters, and in one carbon homologations as in the Arndt-Eistert reaction (Aoyama and Shirori, 1980, Tetrahedron Letters, 21: 4619), the homologation of carbonyl compounds (Aoyama and Shirori, 1980, Tetrahedron Letters, 21: 4619; Hashimoto, Aoyama and Shirori, 1981, Heterocycles 15: 975) and O-methylation of carboxylic acids, phenols and alcohols. Aoyama and his co-workers have successfully used it in numerous reactions previously dominated by diazomethane. TMSD chemistry has been reviewed by Shiori and Aoyama. (Shiori and Aoyama, 1993, in, Dondoni, A. (Ed.), Advances in the Use of Synthons in Organic Chemistry 1: 51-101). The carbon of the ester methyl group produced by reaction with TMSD is derived from the carbon, which bears the diazo group. Nevertheless, the presence of methanol is necessary to bring about conversion to the methyl ester. It is a safe and commercially available reagent.

Lappert and Lorberth reported the first preparation of TMSD in 1967 (Lappert and Lorberth. 1967, Chem. Commun. 16: 836). However since then several synthetic approaches for the preparation of the TMSD have been published. Among these methods, the diazo-transfer reaction of trimethylsilylmethylmagnesium chloride with diphenyl phosphorylazidate (DPPA) (Shioiri, Aoyama and Mori, 1993, Org. Synth. Coll, 8: 612) is the method of choice, because it is most practical and allows a high-yield and large-scale preparation. DPPA is commercially available. However, the precursor may also be prepared in a modified way of the synthesis as described by Shioiri and Yamada (Shioiri and Yamada, 1984, Org. Synth. 62: 187). The large-scale synthesis of TMSD is characterised by a very extensive purification followed by a change of the solvent system from Et₂O to n-hexane (Shioiri, Aoyama and Mori, 1993, Org. Synth. Coil. 8: 612). Presser and Hufner observed that the transfer to n-hexane is not necessary, because the original Et₂O solution is also reactive and can be stored without decomposition for several months (Presser and Hufner, 2004, Monatshefte fur Chemie 135: 1015). TMSD is a most attractive reagent owing to its commercial availability and its compatibility with methanol. Methylation with TMSD is much easier to standardize compared with diazomethane, thus delivering more reproducible results.

In a recent method by Hirano et al. the methyl ester was prepared by solubilization of the low molecular weight hyaluronic acid in DMSO followed by treatment with TMSD. The resulting compounds were isolated by cumbersome precipitation and extraction methods.

Known methods for methyl esterification of HA and subsequent purification are still time consuming and complicated.

There is a need in the art for a simple process for preparation and purification of methyl esters of HA.

### SUMMARY OF THE INVENTION

The processes of the present invention are very rapid due to the very high reactivity of the esterification reagent used. Using the simple and rapid process, esterification can be achieved in 6 hrs. There are fewer side products in the processes of the present invention, and those that are produced are easily removed as compared to previously reported protocols.

In a first aspect, the present invention relates to a method of producing methyl esters of a hyaluronic acid, said method comprising the steps of:

(a) providing a suspension comprising the acid form of the hyaluronic acid in methanol;

(b) adding an organic solution of trimethylsilyldiazomethane to the suspension and mixing, whereby methyl esters of hyaluronic acid are produced; and

(c) recovering the hyaluronic acid methyl esters.

### BRIEF DESCRIPTION OF DRAWINGS

FIG. 1 shows the molecular structure of an esterified hyaluronic acid according to the invention.

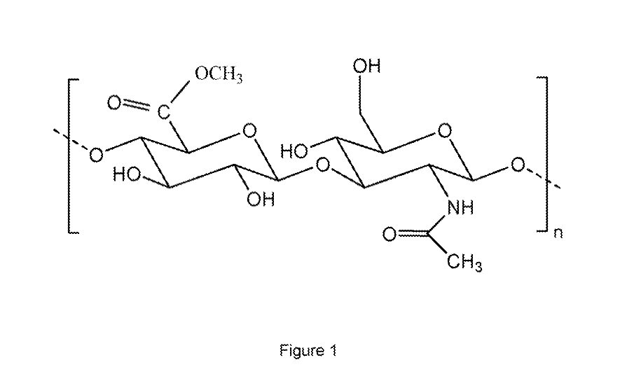

FIG. 2 shows the structural formula of the sodium salt of HA.

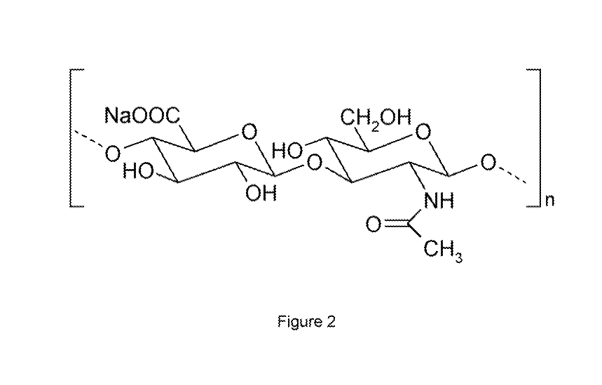

FIG. 3 shows the structure of trimethylsilyldiazomethane or TMSD.

FIG. 4 shows the reaction scheme of TMSD with carboxylic acids in solutions containing methanol, which results in the corresponding methyl esters in excellent yields.

FIG. 5 shows the reaction scheme of HA with TMSD in solutions containing methanol, according to the present invention.

FIG. 6 shows the structure of a methyl esterified HA according to the invention.

### DETAILED DESCRIPTION OF THE INVENTION

The present invention relates to processes of producing methyl esters of hyaluronic acid comprising the following steps:

(a) providing a suspension comprising the acid form of the hyaluronic acid in methanol;

(b) adding an organic solution of trimethylsilyldiazomethane to the suspension and mixing, whereby methyl esters of hyaluronic acid are produced; and

(c) recovering the hyaluronic acid methyl esters.

Under the methods of the present invention, HA can be controllably methyl esterified with a wide range of properties for different applications. These include: (i) topical cosmetic formulations, (ii) advanced delivery systems such as micro and nanoparticles, micro and nanocapsules, polymeric micelles for cosmetic, biomedical and pharmaceutical applications, (iii) wound healing and tissue engineering scaffolding structures in various forms (dressings, films, fibers etc.) and a wide range of other biomedical applications.

Methyl-esterified HA can also be applied in combination with other biopolymers to improve for example its emulsifying properties towards technical, biomedical and pharmaceutical applications.

The term “hyaluronic acid” or “HA” is defined herein as an unsulphated glycosaminoglycan composed of repeating disaccharide units of N-acetylglucosamine (GlcNAc) and glucuronic acid (GlcUA) linked together by alternating beta-1,4 and beta-1,3 glycosidic bonds, which occurs naturally in cell surfaces, in the basic extracellular substances of the connective tissue of vertebrates, in the synovial fluid of the joints, in the endobulbar fluid of the eye, in human umbilical cord tissue and in rooster combs, Hyaluronic acid is also known as hyaluronan, hyaluronate, or HA. The terms hyaluronan and hyaluronic acid are used interchangeably herein.

It is understood herein that the term “hyaluronic acid” encompasses a group of polysaccharides of N-acetyl-D-glucosamine and D-glucuronic acid with varying molecular weights or even degraded fractions of the same.

The present invention describes a simple process for preparation of methyl esters of HA avoiding the use of tedious processes using tetrabutyl derivatives or use of toxic diazomethane, which is prepared instantly for reaction. A problem to be solved by the present invention is how to prepare methyl esters of hyaluronic acid controllably in an extremely simple and facile process.

The HA used in the present invention may be any available HA, including HA derived from natural tissues including the connective tissue of vertebrates, the human umbilical cord and from rooster combs. In a particular embodiment the hyaluronic acid or salt thereof is recombinantly produced, preferably by a Gram-positive bacterium or host cell, more preferably by a bacterium of the genus Bacillus. In another embodiment, the HA is obtained from a Streptococcus cell.

The host cell may be any Bacillus cell suitable for recombinant production of hyaluronic acid. The Bacillus host cell may be a wild-type Bacillus cell or a mutant thereof. Bacillus cells useful in the practice of the present invention include, but are not limited to, Bacillus agaraderhens, Bacillus alkalophilus, Bacillus amyloliquefaciens, Bacillus brevis, Bacillus circulars, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, and Bacillus thuringiensis cells. Mutant Bacillus subtilis cells particularly adapted for recombinant expression are described in WO 98/22598. Non-encapsulating Bacillus cells are particularly useful in the present invention.

In a preferred embodiment, the Bacillus host cell is a Bacillus amyloliquefaciens, Bacillus clausii, Bacillus lentus, Bacillus licheniformis, Bacillus stearothermophilus or Bacillus subtilis cell. In a more preferred embodiment, the Bacillus cell is a Bacillus amyloliquefaciens cell. In another more preferred embodiment, the Bacillus cell is a Bacillus clausii cell. In another more preferred embodiment, the Bacillus cell is a Bacillus lentus cell. In another more preferred embodiment, the Bacillus cell is a Bacillus licheniformis cell. In another more preferred embodiment, the Bacillus cell is a Bacillus subtilis cell. In a most preferred embodiment, the Bacillus host cell is Bacillus subtilis A164Δ5 (see U.S. Pat. No. 5,891,701) or Bacillus subtilis 168Δ4.

The average molecular weight of the hyaluronic acid may be determined using standard methods in the art, such as those described by Ueno et al., 1988, Chem. Pharm. Bull. 36: 4971˜4975; Wyatt, 1993, Anal. Chim. Acta 272; 1-40; and Wyatt Technologies, 1999, “Light Scattering University DAWN Course Manual” and “DAWN EOS Manual” Wyatt Technology Corporation, Santa Barbara, Calif.

In a preferred embodiment, the hyaluronic acid, or salt thereof, of the present invention has a molecular weight of about 500 to about 10,000,000 Da; preferably about 10,000 to about 1,500,000 Da. In another more preferred embodiment the hyaluronic acid, or salt thereof has an average molecular weight of between about 10,000 and 50,000 Da. In another more preferred embodiment the hyaluronic acid, or salt thereof has an average molecular weight of between about 50,000 and 500,000 Da, preferably between about 80,000 and 300,000 Da. In yet another more preferred embodiment the hyaluronic acid, or salt thereof has an average molecular weight of between about 500,000 and 1,500,000 Da, or preferably between about 750,000 and 1,000,000 Da.

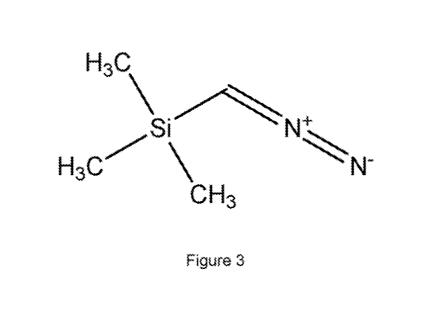

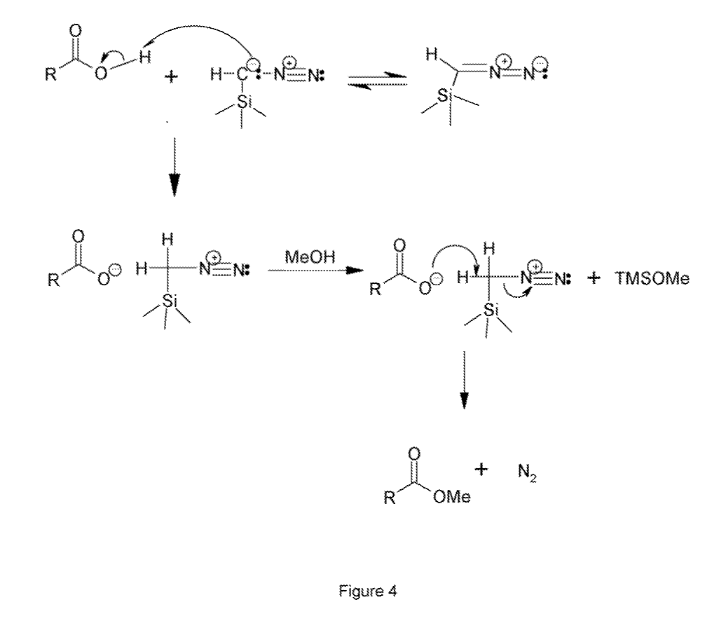

In the processes of the present invention, the trimethylsilyldiazomethane used may be any available trimethylsilyldiazomethane, TMSD, the structure of TMSD is shown in FIG. 3, TMSD is a stable and safe substitute for highly toxic and explosive diazomethane in the Arndt-Eistert synthesis and homologation of carbonyl compounds. It smoothly reacts with carboxylic acids in solutions containing methanol to give the corresponding methyl esters in excellent yields. It is available commercially and is much safer to use than diazomethane. TMSD is a greenish-yellow liquid, which is stable in hydrocarbon solution (Dietmar Seyferth et al., 1972, Journal of Organometallic Chemistry 44: 279). The reaction of TMSD with carboxylic acids is proposed to occur by a significantly different reaction mechanism than that of diazomethane with carboxylic acids. The reaction must have methanol present to get good yields of the desired methyl ester (FIG. 4).

One of the protons in resulting methyl ester originates from the diazomethane derivative, one from methanol, and the remaining one is the donated acidic proton from the carboxylic acid.

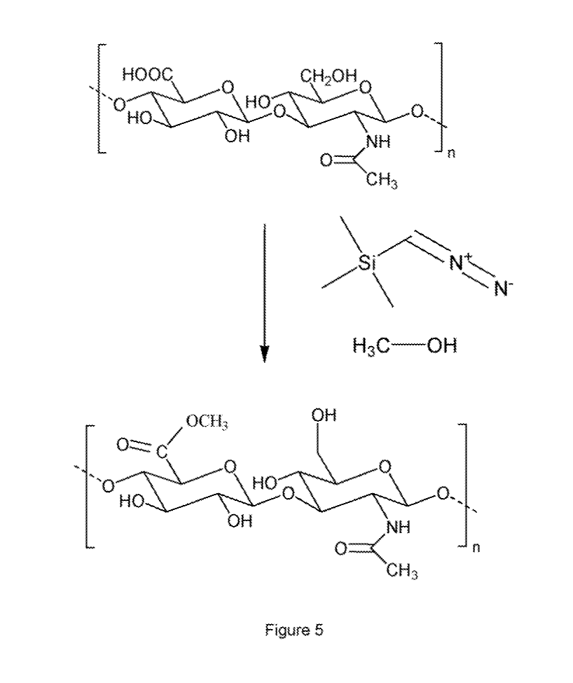

In the methods of the present invention, HA is reacted with TMSD according to the reaction shown in FIG. 5.

In a particular embodiment of the present invention the aqueous solution of a) is prepared by conversion of sodium salt of hyaluronan into its acid from. In the process hyaluronan was dissolved in water and applied to a cation exchange column and the acidic fraction (HA H⁺) was collected and then freeze dried.

In another particular embodiment of the present invention the acid form of hyaluronic acid is suspended in protic or aprotic solvents. The solvents chosen are preferably low boiling miscible liquids. The low-boiling miscible liquids may be selected from the group consisting of diethyl ether, methanol, dichloromethane, tetrahydrofuran, dioxane, dimethylsulphoxide, dimethyl formamide, dimethyl acetamide etc. In a more particular embodiment of the present invention the solvents of the reaction may preferably have methanol as one of the component during the reaction.

In a preferred embodiment of the invention, the TMSD is provided in an organic solution of trimethylsilyldiazomethane which comprises diethylether or hexane.

In a particular embodiment of the present invention the temperature of the reaction is lowered to around 0° C. to 5° C. after suspending HA in the reaction mixture and is kept between 0° C. and 25° C. during the reaction to avoid evaporation of TMSD. In a more particular embodiment of the present invention the temperature of the reaction is kept at 0° C. and 5° C. during the reaction. In a preferred embodiment of the first aspect, the suspension comprising the acid form of the hyaluronic acid in methanol has a temperature in the range of −20° C. to 20° C., preferably in the range of −10° C. to 10° C., more preferably in the range of −5° C. to 5° C., and most preferably in the range of 0° C. to 5° C., before addition of the organic solution.

To achieve the reaction the esterification reagent is added to the reaction mixture. After complete addition of the esterification reagent the liquid reaction mixture is stirred to ensure full reaction. A preferred embodiment relates to a method of the first aspect, wherein the organic solution of trimethylsilyldiazomethane is added to the suspension while the suspension is stirred.

Another preferred embodiment also relates to the method of the first aspect, wherein the mixing is done by stirring. Preferably the mixing is continued for at least 5 minutes, preferably for at least 10 minutes. 20 minutes, 30 minutes, 40 minutes, 50 minutes, 1 hour, 2 hours, 3 hours, 4 hours, 5 hours, 6 hours, 7 hours, 8 hours, 9 hours, 10 hours, 11 hours, or most preferably for at least 12 hours.

In another preferred embodiment the mixing is done at a temperature in the range of −20° C. to 20° C., preferably in the range of −10° C. to 10° C., more preferably in the range of −5° C. to 5° C., and most preferably in the range of 0° C. to 5° C.

A preferred embodiment of the invention relates to the method of the first aspect, wherein the molar ratio of hyaluronic acid and trimethylsilyldiazomethane in the mixture is in the range of 1:0.01 to 1:100, preferably in the range of 1:0.05 to 1:50, and most preferably in the range of 1:0.1 to 1:10. The HA-TMSD molar ratio in the mixture ranges most preferably between 1:0.5 and 1:4. In a preferred embodiment, 100 mg of HA (0.25 mmol) in solvents containing methanol was treated with 125 microliters of TMSD (2 M solution in diethyl ether, 0.25 mmol) in a ratio of approximately 1:1, resulting in ˜50% esterification of HA. In another preferred embodiment, the same concentration of HA (0.25 mmol) was treated with a higher amount of esterifying reagent (250 microliters) in a ratio of 1:2, resulting in 80% esterification of HA. In a more preferred embodiment, 0.125 mmol of HA was treated with 500 microliters of TMSD in a ratio of approximately 1:4, resulting in 100% esterification of HA.

After the reaction is finished, the esterified HA product is isolated, preferably the hyaluronic acid methyl esters are recovered by filtration; preferably the resulting solid filtrate comprising hyaluronic acid methyl esters is washed at least once with at least one volume of one or more organic solvent, preferably washed at least twice, preferably with methanol and/or diethyl ether; more preferably the washed solid filtrate comprising hyaluronic acid methyl esters is dried, dialyzed and lyophilized.

For purification of the derivatized product, it is centrifuged, and washed with a solvent such as ethanol, methanol or acetone. The product may be dialyzed to provide a substantially pure methylated HA product.

The esterified HA may be formulated into a dry powder, e.g., by lyophilization or by spray drying.

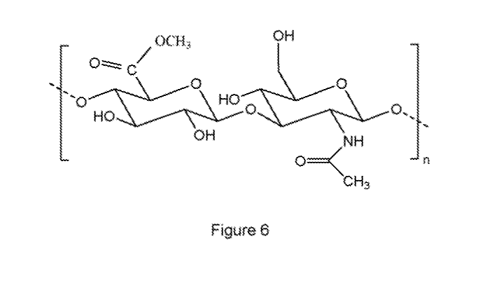

In a particular embodiment, the present invention discloses a methyl esterified HA with the structure presented in FIG. 6.

The methyl esterified HA products can be characterized by proton NMR. The degree of esterification or degree of substitution (DS, in %) is determined from the integration values of the methyl ester proton 3.84 ppm (3H) to the N-acetyl protons of hyaluronic acid (—NHCOCH₃, 3H, 2.0 ppm).

The invention described and claimed herein is not to be limited in scope by the specific embodiments or examples disclosed, since these are intended primarily as illustrations of the invention. Any equivalent aspects are intended to be within the scope of this invention. Indeed, various modifications of the invention in addition to those shown and described herein will become apparent to those skilled in the art from the description and examples herein. Such modifications are also intended to fall within the scope of the appended claims.

### EXAMPLES

### Example 1

Medium molecular weight hyaluronic acid (750,000-1,000,000 Dalton) was converted into H⁺ form by passing through cation exchange resin (Dowex 50 WX8200). It was lyophilized in a freeze drier.

The resulting product (50 mg, 0.125 mmol) was suspended in methanol (10 mL) at room temperature (20° C.). The temperature of the reaction mixture was then decreased to 0° C. To the above reaction mixture etheric solution of freshly prepared diazomethane was added (10 mL). The reaction was done under stirring at low temperature (0-5° C.). The molar ratio of hyaluronic acid to diazomethane was 1:8. After 4 h, the reaction mixture was filtered. It was washed with methanol (3×50 mL) and diethyl ether (3×50 mL). The resulting solid was dried under vacuum. It was dissolved in deionised water and lyophilized. The yield of the product was >90% (47 mg). The degree of substitution of the resulting product was 1.0.

### Example 2

Medium molecular weight hyaluronic acid (750,000-1,000,000 daltons) was converted into H⁺ form by passing through cation exchange resin (Dowex 50 WX8-200). It was lyophilized in a freeze drier.

The resulting product (100 mg 0.25 mmol) was suspended in methanol (10 mL) at room temperature (20° C.). The temperature of the reaction mixture was then decreased to 0° C. To the above reaction mixture etheric solution of trimethylsilyldiazomethane (125 microliters, 0.25 mmol) was added. The reaction was carried out under stirring at low temperature (0-5° C.). The molar ratio of hyaluronic acid to TMSD was 1:1. After 6 h the reaction mixture was filtered. It was washed with organic solvents viz. methanol and diethyl ether (3×50 mL each). The resulting solid was dried. It was dialyzed and lyophilized. The yield of the product was >90% (93 mg). The DS obtained was ˜0.5.

### Example 3

Medium molecular weight hyaluronic acid (750.000-1,000,000 daltons) was converted into H⁺ form by treatment with 0.6 N ethanolic HCl. It was lyophilized in a freeze drier.

The resulting product (100 mg, 0.25 mmol) was suspended in methanol (10 mL). The temperature of the reaction mixture was then decreased to 0° C. A portion of etheric solution of TMSD (125 microliters, 0.25 mmol) was added to the above reaction mixture. The reaction was done with stirring at low temperature (0-5° C.). The molar ratio of hyaluronic acid to TMSD was 1:1. After 6 h the reaction mixture was filtered. It was washed with organic solvents, viz. methanol and diethyl ether. The resulting solid was dried, dialyzed and lyophilized. The yield of the product was >90% (94 mg). The DS obtained was ˜0.5.

Using the above processes different methyl esterified hyaluronic acid derivatives with varying percent esterification were obtained by treatment with varying molar amounts of TMSD. The %-esterification was calculated by comparing the signal at 2.02 (3H, —NHCOCH₃) and 3.84 (protons of methyl esters of hyaluronate). The yields of the modified products are >90%.

### Example 4

¹H NMR (Varian-300) was used to determine the final functionality and purity of the esterified hyaluronic acid (in D₂O). ²H₂O was used as analytical solvent and the ²HOH peak at 4.79 ppm was used as the reference line. Proton-NMR of the methyl esterified hyaluronic acid revealed a sharp peak at 3.84 ppm. The degree of modification was determined from the relative integrations of the methyl ester to N-acetyl protons of hyaluronic acid (—NHCOCH₃, 3H, 2.0 ppm). Methyl esters with different degrees of esterification were obtained by varying the HA-TMSD molar ratio (1:0.5 to 1:4) as discussed earlier.

1-15. (canceled)

16. A method of producing methyl esters of a hyaluronic acid, said method comprising the steps of:
(a) providing a suspension comprising the acid form of the hyaluronic acid in methanol;
(b) adding an organic solution of trimethylsilyldiazomethane to the suspension and mixing, whereby methyl esters of hyaluronic acid are produced; and
(c) recovering the hyaluronic acid methyl esters.

17. The method of claim 16, wherein the hyaluronic acid has an average molecular weight of between 500 and 10,000,000 Da.

18. The method of claim 17, wherein the hyaluronic acid has an average molecular weight of between 10,000 and 50,000 Da.

19. The method of claim 17, wherein the hyaluronic acid has an average molecular weight of between 50,000 and 500,000 Da.

20. The method of claim 17, wherein the hyaluronic acid has an average molecular weight of between 500,000 and 1,500,000 Da.

21. The method of claim 16, wherein the organic solution of trimethylsilyldiazomethane comprises diethylether or hexane.

22. The method of claim 16, wherein the molar ratio of hyaluronic acid and trimethylsilyldiazomethane in the mixture is in the range of 1:0.01 to 1:100.

23. The method of claim 16, wherein the suspension comprising the acid form of the hyaluronic acid in methanol has a temperature in the range of −20° C. to 20° C. before addition of the organic solution.

24. The method of claim 16, wherein the organic solution of trimethylsilyldiazomethane is added to the suspension while the suspension is stirred.

25. The method of claim 16, wherein the mixing is done by stirring.

26. The method of claim 16, wherein the mixing is continued for at least 5 minutes.

27. The method of claim 16, wherein the mixing is done at a temperature in the range of −20° C. to 20° C.

28. The method of claim 16, wherein the hyaluronic acid methyl esters are recovered by filtration.

29. The method of claim 28, wherein the solid filtrate comprising hyaluronic acid methyl esters is washed at least once with at least one volume of one or more organic solvent.

30. The method of claim 29, wherein washed solid filtrate comprising hyaluronic acid methyl esters is dried, dialyzed and lyophilized.
